(19) United States
(12) Patent Application Publication
(10) Pub. No.: US 2025/0373717 A1
(43) Pub. Date: Dec. 4, 2025

(54) FOLDABLE ELECTRONIC DEVICE

(71) Applicant: SYNCMOLD ENTERPRISE CORP., New Taipei City (TW)

(72) Inventors: Chun-Hao Huang, New Taipei City (TW); Chien-Cheng Yeh, New Taipei City (TW)

(21) Appl. No.: 19/208,624

(22) Filed: May 15, 2025

Related U.S. Application Data
(60) Provisional application No. 63/653,528, filed on May 30, 2024.

(30) Foreign Application Priority Data
Mar. 26, 2025 (TW) 114111504

(51) Int. Cl. H04M 1/02; G06F 1/16

(52) U.S. Cl. CPC H04M 1/0216; G06F 1/1681; H04M 1/0268

(57) ABSTRACT

A foldable electronic device is provided and comprises a central base, a pivot module, two panel bodies, two transmission members, two connecting members, a synchronization module, an elastic module and a flexible screen. The pivot module is disposed in the central base. The panel bodies pivot relative to the central base. The transmission members connect the pivot module, the synchronization module and the elastic module. The connecting members connect the panel bodies and the transmission members. The synchronization module drives the transmission members to rotate synchronously and reversely. The elastic module connects the pivot module. The flexible screen is disposed on the central base and the panel bodies and includes a bendable area.

### CROSS-REFERENCE TO RELATED APPLICATIONS

This application claims the benefit of U.S. Provisional Application Ser. No. 63/653,528 filed on May 30, 2024, and the benefit of Taiwan Patent Application Serial No. 114111504 filed on Mar. 26, 2025. The entirety of each application is incorporated herein by reference.

### BACKGROUND

### 1. Technical Field

The present disclosure relates to a foldable electronic device, and more particularly, to a foldable electronic device having a flexible screen.

### 2. Description of Related Art

EP4199485 discloses an electronic device. The electronic device comprises a first housing, a second housing, and a hinge structure connected to the first housing and the second housing. The hinge structure includes a fixed structure, a first rotary structure, a second rotary structure, an arm structure and a torque structure. The arm structure has a first arm shaft, a second arm shaft, a first arm, a second arm, a gear structure, a fixed member and a stopper. The first rotary structure has a first sliding groove, and the second rotary structure has a second sliding groove. The first arm is connected to the first sliding groove via a first sliding pin, and the second arm is connected to the second sliding groove via a second sliding pin. When the first housing and the second housing rotate about a rotation axe R1 and a rotation axe R2 in opposite directions, respectively, the first arm and the first sliding pin may slide relative to the first rotary structure and slide from one end of the first sliding groove to the other end, and the second arm and the second sliding pin may slide relative to the second rotary structure and slide from one end of the second sliding groove to the other end. Therefore, the first housing and the second housing may be relatively unfolded or relatively folded.

In the electronic device disclosed in EP4199485, the first arm and the first sliding groove are connected via a first sliding pin, and the second arm and the second sliding groove are connected via a second sliding pin. The present disclosure further provides a foldable electronic device having a structure different from that shown in EP4199485.

### SUMMARY

The present disclosure provides a foldable electronic device, which comprises: a central base including a body portion, at least one first arc-shaped slider, at least one second arc-shaped slider and a shell, wherein the first arc-shaped slider and the second arc-shaped slider are respectively formed on the body portion and spaced apart from each other; a pivot module disposed in the central base and including a first shaft and a second shaft connected to the body portion, wherein the first shaft extends along a first axis, and the second shaft extends along a second axis; a first panel body including a first wing member, wherein the first wing member has at least one first arc-shaped slideway and a first connecting rod portion, and the first arc-shaped slider is slidably disposed in the first arc-shaped slideway, whereby the first wing member is able to pivot relative to the body portion with a first inner virtual axis as a center; a first transmission member sleeved on the first shaft; a first connecting member including a first pivoting portion and a first straight slide groove, wherein the first pivoting portion is pivotally connected to the first connecting rod portion and jointly defines a first outer virtual axis, whereby the first connecting member is able to rotate relative to the first wing member about the first outer virtual axis, and wherein the first transmission member is slidably disposed in the first straight slide groove, whereby the first connecting member is able to slide linearly relative to the first transmission member; a second panel body including a second wing member, wherein the second wing member has at least one second arc-shaped slideway and a second connecting rod portion, and the second arc-shaped slider is slidably disposed in the second arc-shaped slideway, whereby the second wing member is able to pivot relative to the body portion with a second inner virtual axis as a center; a second transmission member sleeved on the second shaft; a second connecting member including a second pivoting portion and a second straight slide groove, wherein the second pivoting portion is pivotally connected to the second connecting rod portion and jointly defines a second outer virtual axis, whereby the second connecting member is able to rotate relative to the second wing member about the second outer virtual axis, and wherein the second transmission member is slidably disposed in the second straight slide groove, whereby the second connecting member is able to slide linearly relative to the second transmission member; a synchronization module connecting the first transmission member and the second transmission member, and enabling the first transmission member and the second transmission member to rotate synchronously and reversely; an elastic module including a pushing member, wherein the pushing member is slidably sleeved on the first shaft and the second shaft, and is movably engaged with the first transmission member and the second transmission member; and a flexible screen disposed on the first panel body, the second panel body and the central base, and including a bendable area; wherein the first panel body and the second panel body are able to transform between an unfolded state and a folded state, wherein when the first panel body and the second panel body are in the unfolded state, the flexible screen is flattened, the first panel body, the second panel body and the central base jointly support the bendable area, and the first wing member and the second wing member abut against a top side of the shell, and wherein when the first panel body and the second panel body are in the folded state, the bendable area of the flexible screen is bent, the first panel body, the second panel body and the central base jointly define an accommodation space to accommodate the bendable area, and the first wing member and the second wing member are away from the shell.

In the aforementioned foldable electronic device, the first connecting member further includes a first body, the first pivoting portion is disposed on the first body and located between the first body and the first wing member, the first straight slide groove is surrounded and defined by the first body and extends along a radial direction of the first axis, and wherein the second connecting member further includes a second body, the second pivoting portion is disposed on the second body and located between the second body and the second wing member, the second straight slide groove is surrounded and defined by the second body and extends along a radial direction of the second axis, wherein when the first panel body and the second panel body are in the unfolded state, the first body and the first wing member are approximately parallel to each other, and the second body and the second wing member are approximately parallel to each other, and wherein when the first panel body and the second panel body are in the folded state, the first body and the first wing member are obliquely intersected, and the second body and the second wing member are obliquely intersected.

In the aforementioned foldable electronic device, the first connecting member further includes a first inner recess portion disposed in the first body, and there is a first vertical distance between the first inner recess portion and the first wing member, and the second connecting member further includes a second inner recess portion disposed in the second body, and there is a second vertical distance between the second inner recess portion and the second wing member, wherein the first vertical distance and the second vertical distance are the greatest when the first panel body and the second panel body are in the unfolded state, and wherein the first vertical distance and the second vertical distance are the smallest when the first panel body and the second panel body are in the folded state.

In the aforementioned foldable electronic device, the first transmission member includes a first bending plate, the first bending plate extends along a radial direction of the first axis and is bent, wherein the second transmission member includes a second bending plate, the second bending plate extends along a radial direction of the second axis and is bent, and wherein when the first panel body and the second panel body are in the unfolded state, the first bending plate is accommodated in the first inner recess portion, and the second bending plate is accommodated in the second inner recess portion, and wherein when the first panel body and the second panel body are in the folded state, the first bending plate is away from the first inner recess portion, and the second bending plate is away from the second inner recess portion.

In the aforementioned foldable electronic device, the first transmission member further includes a first straight slider, and the first straight slider extends outward from the first bending plate along the radial direction of the first axis and is slidably disposed in the first straight slide groove, and wherein the second transmission member further includes a second straight slider, and the second straight slider extends outward from the second bending plate along the radial direction of the second axis and is slidably disposed in the second straight slide groove.

In the aforementioned foldable electronic device, the synchronization module includes a first main gear, a second main gear, a first auxiliary gear and a second auxiliary gear, wherein the first main gear is sleeved on the first shaft and fixedly connected to the first transmission member to move together with the first transmission member, the second main gear is sleeved on the second shaft and fixedly connected to the second transmission member to move together with the second transmission member, and the first auxiliary gear and the second auxiliary gear are reversely rotatably connected to the body portion and mesh with each other, and wherein the first auxiliary gear is reversely rotatably engaged with the first main gear, and the second auxiliary gear is reversely rotatably engaged with the second main gear.

In the aforementioned foldable electronic device, the synchronization module further includes a gear fixing piece, and the gear fixing piece has a first through hole and a second through hole, and wherein the first shaft and the first main gear insert through the first through hole, and the second shaft and the second main gear insert through the second through hole, so that the gear fixing piece is disposed between the first main gear and the second main gear and the first transmission member and the second transmission member, and wherein the first main gear and the second main gear are disposed between the body portion and the gear fixing piece.

In the aforementioned foldable electronic device, the first body and the first pivoting portion jointly have a roughly T-shaped cross section, and the second body and the second pivoting portion jointly have a roughly T-shaped cross section.

In the aforementioned foldable electronic device, the first axis, the first inner virtual axis, the first outer virtual axis, the second axis, the second inner virtual axis and the second outer virtual axis are parallel to each other.

In the aforementioned foldable electronic device, the first connecting rod portion has two first pivot joint holes and a first rod body, the first pivoting portion is roughly a hollow cylinder and has a first pivoting hole, the first pivot joint holes are corresponding to and spaced apart from each other and are formed along the first outer virtual axis, and the first rod body passes through the first pivoting hole and two opposite ends of the first rod body respectively insert through the first pivot joint holes, wherein the second connecting rod portion has two second pivot joint holes and a second rod body, the second pivoting portion is roughly a hollow cylinder and has a second pivoting hole, the second pivot joint holes are corresponding to and spaced apart from each other and are formed along the second outer virtual axis, and the second rod body passes through the second pivoting hole and two opposite ends of the second rod body respectively insert through the second pivot joint holes.

In the aforementioned foldable electronic device, the first transmission member includes a first driving cam, the second transmission member includes a second driving cam, and the pushing member has a first driven cam and a second driven cam, and wherein the first driving cam is slidably sleeved on the first shaft along the first axis and fits with the first driven cam, and the second driving cam is slidably sleeved on the second shaft along the second axis and fits with the second driven cam.

In the aforementioned foldable electronic device, the pivot module further includes a fixed base, a first shaft hole and a second shaft hole, and the fixed base has a first wing portion and a second wing portion, wherein the first shaft hole is formed through the first wing portion along the first axis, and the first shaft inserts through the first shaft hole, and wherein the second shaft hole is formed through the second wing portion along the second axis, and the second shaft inserts through the second shaft hole.

In the aforementioned foldable electronic device, the first driven cam is sleeved on the first shaft, and the second driven cam is sleeved on the second shaft, wherein the elastic module further includes a first elastic member and a second elastic member respectively sleeved on the first shaft and the second shaft, two ends of the first elastic member respectively abut against the first wing portion and the first driven cam, and two ends of the second elastic member respectively abut against the second wing portion and the second driven cam, wherein when the first panel body and the second panel body are in a half-folded state between the unfolded state and the folded state, the first driving cam and the second driving cam abut against the first driven cam and the second driven cam, the first elastic member and the second elastic member are compressed, and wherein when the first panel body and the second panel body are in the unfolded state or the folded state, the first elastic member and the second elastic member are released correspondingly.

As can be seen from the above, in the foldable electronic device of the present disclosure, the first connecting member and the second connecting member pivot relative to the first wing member and the second wing member, respectively, and the first transmission member and the second transmission member are driven to slide linearly relative to the first connecting member and the second connecting member, respectively. Therefore, the present disclosure improves structural complexity of the existing structure, such as the need to add additional slide grooves on the wing members and the need for the transmission members to be connected to the wing members via the sliding pins.

### BRIEF DESCRIPTION OF THE DRAWINGS

FIG. 1 is an overall schematic view of a foldable electronic device according to the present disclosure in an unfolded state.

FIG. 2 is an exploded schematic view of the foldable electronic device according to the present disclosure.

FIG. 3 is an exploded schematic view of some components of the foldable electronic device according to the present disclosure.

FIG. 4 is an exploded schematic view of some components of the foldable electronic device according to the present disclosure from a different viewing angle.

FIG. 5 is an exploded schematic view of some components of the foldable electronic device according to the present disclosure from a different viewing angle.

FIG. 6 is a top view of a pivot module, a first transmission member, a second transmission member and an elastic module of the foldable electronic device according to the present disclosure in the unfolded state.

FIG. 7 is a top view of the pivot module, the first transmission member, the second transmission member and the elastic module of the foldable electronic device according to the present disclosure in a half-folded state.

FIG. 8 is a top view of the pivot module, the first transmission member, the second transmission member and the elastic module of the foldable electronic device according to the present disclosure in the folded state.

FIG. 9 is a cross-sectional schematic view of the foldable electronic device according to the present disclosure in the unfolded state.

FIG. 10 is a cross-sectional schematic view of the foldable electronic device according to the present disclosure in the unfolded state.

FIG. 11 is a front view of the foldable electronic device according to the present disclosure in the half-folded state.

FIG. 12 is a front view of the foldable electronic device according to the present disclosure in the folded state.

### DETAILED DESCRIPTION

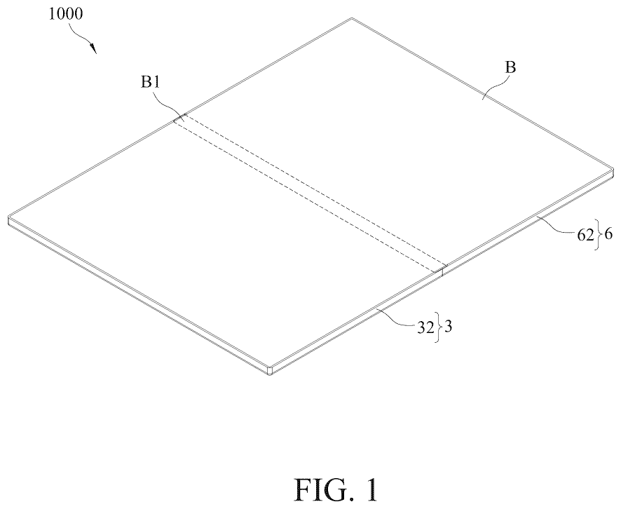

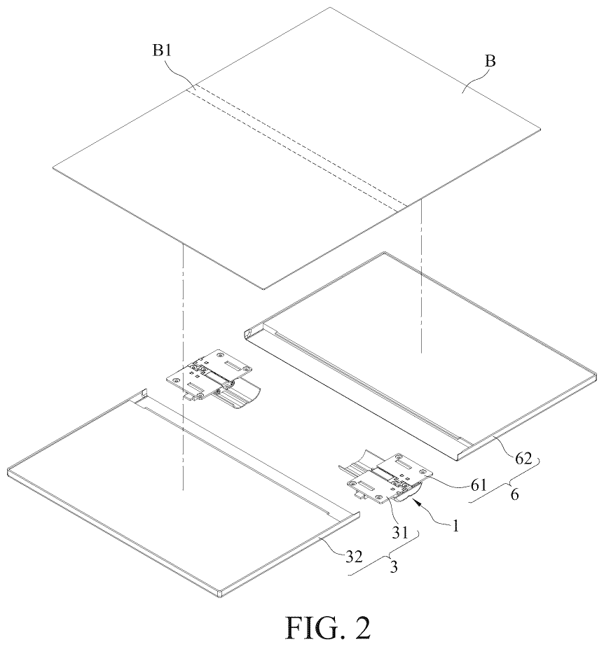

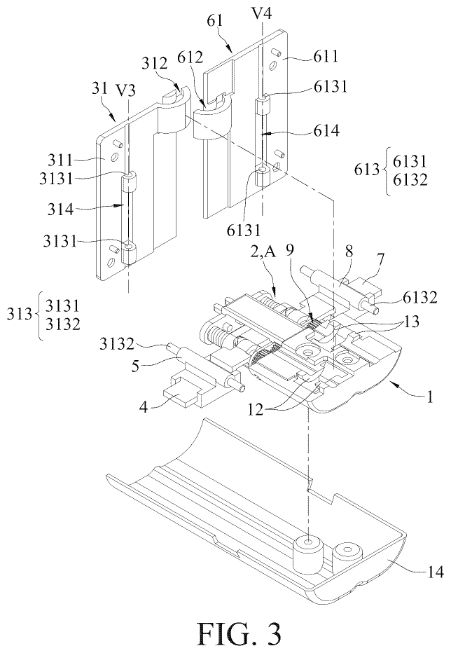

Referring to FIG. 1, FIG. 2 and FIG. 3, a foldable electronic device 1000 includes a central base 1, a pivot module 2, a first panel body 3, a first transmission member 4, a first connecting member 5, a second panel body 6, a second transmission member 7, a second connecting member 8, a synchronization module 9, an elastic module A, and a flexible screen B. The first panel body 3 and the second panel body 6 are respectively pivotally connected to two sides of the central base 1, the pivot module 2 is disposed in the central base 1, the first transmission member 4 and the second transmission member 7 are respectively connected to two sides of the pivot module 2, the first connecting member 5 connects the first panel body 3 and the first transmission member 4, and the second connecting member 8 connects the second panel body 6 and the second transmission member 7. The synchronization module 9 is disposed between the central base 1 and the pivot module 2, and connected to the first transmission member 4 and the second transmission member 7. The elastic module A is disposed on the central base 1 and connected to the pivot module 2, and the flexible screen B is disposed on the central base 1, the first panel body 3 and the second panel body 6. It should be noted that some components of the foldable electronic device 1000 of the present invention may be a group or a plurality of groups. The following is a simplified description, and only one group is used as an example.

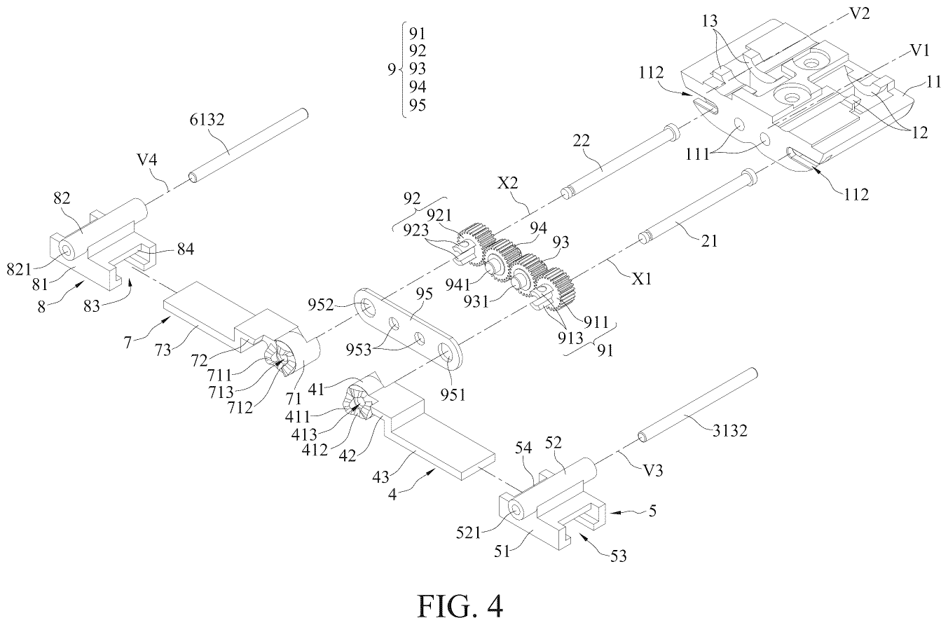

Please refer to FIG. 4. The central base 1 includes a body portion 11, two first arc-shaped sliders 12, two second arc-shaped sliders 13, and a shell 14. The body portion 11 has two concave holes 111 and two embedding grooves 112. The concave holes 111 are spaced apart from each other, and the embedding grooves 112 are respectively located at outer sides of the concave holes 111. The first arc-shaped sliders 12 are roughly semi-arc-shaped, protruding from the body portion 11 and spaced apart from each other. The first arc-shaped sliders 12 are adjacent to two adjacent sides of the body portion 11 (i.e., adjacent to the first panel body 3 and a front end of the body portion 11), and axle centers of the first arc-shaped sliders 12 can be defined as a first inner virtual axis V1. The second arc-shaped sliders 13 are roughly semi-arc-shaped, protruding from the body portion 11 and spaced apart from each other. The second arc-shaped sliders 13 are adjacent to two other adjacent sides of the body portion 11 (i.e., adjacent to the second panel body 6 and a rear end of the body portion 11). The second arc-shaped sliders 13 are spaced apart from and diagonally correspond to the first arc-shaped sliders 12, and axle centers of the second arc-shaped sliders 13 can be defined as a second inner virtual axis V2. The shell 14 covers the bottom and front sides of the body portion 11.

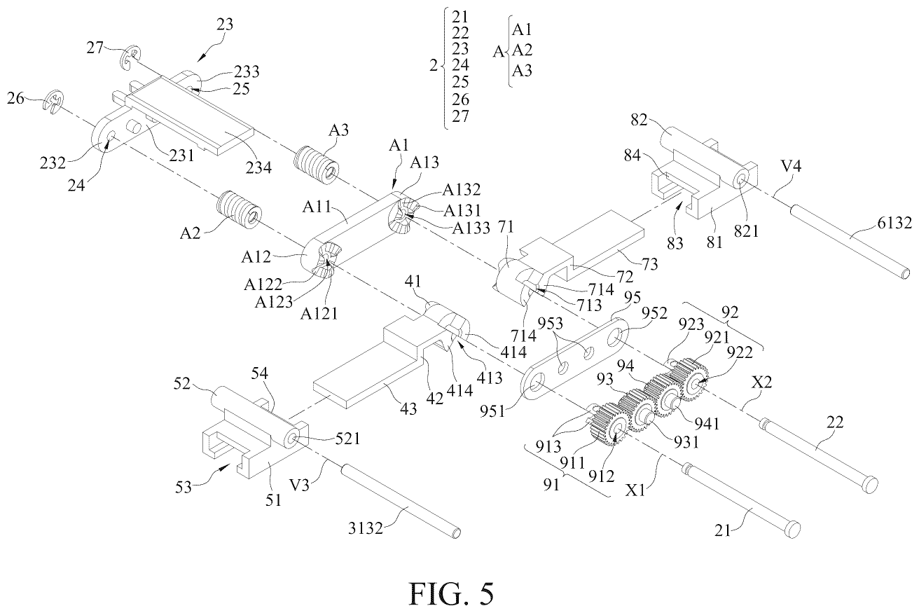

Please refer to FIG. 5, the pivot module 2 includes a first shaft 21, a second shaft 22, a fixed base 23, a first shaft hole 24, a second shaft hole 25, a first retaining ring 26 and a second retaining ring 27. The first shaft 21 and the second shaft 22 are respectively embedded in the embedding groove 112 along a first axis X1 and a second axis X2. The fixed base 23 has a base body 231, a first wing portion 232, a second wing portion 233 and an upper cover plate 234. The base body 231 is disposed on the shell 14 and is spaced apart from the body portion 11. The first wing portion 232 and the second wing portion 233 extend outward from opposite sides of the base body 231 and are spaced apart from each other. The upper cover plate 234 extends outward from the upper edge of the base body 231, so that the fixed base 23 is roughly T-shaped. The first shaft hole 24 penetrates through the first wing portion 232 and is used for the first shaft 21 to insert through and pivotally connect. The second shaft hole 25 penetrates through the second wing portion 233 and is used for the second shaft 22 to insert through and pivotally connect. The first retaining ring 26 is buckled at one end of the first shaft 21 away from the body portion 11, and the second retaining ring 27 is buckled at one end of the second shaft 22 away from the body portion 11.

The first panel body 3 includes a first wing member 31 and a first panel housing 32. The first wing member 31 has a first wing body 311, two first arc-shaped slideways 312, a first connecting rod portion 313 and a first receiving groove 314. The first wing body 311 is roughly in the shape of a square plate. The first arc-shaped slideways 312 are spaced apart from each other, recessed and formed on one side of the first wing body 311 adjacent to the body portion 11, and are respectively provided for the first arc-shaped sliders 12 to slide correspondingly, so that the first wing member 31 can pivot relative to the body portion 11 with the first inner virtual axis V1 as the center. The first connecting rod portion 313 has two first pivot joint holes 3131 and a first rod body 3132. The first pivot joint holes 3131 correspond to each other and are spaced apart from each other, and are penetrated along a first outer virtual axis V3. Two opposite ends of the first rod body 3132 are respectively passed through the first pivot joint holes 3131. The first receiving groove 314 is formed through the first wing body 311 and is located correspondingly between the first pivot joint holes 3131. The first panel housing 32 is roughly in the shape of a square and is fixed to the first wing member 31. In addition, the first panel body 3 also includes electronic components, which will not be described in detail here.

The first transmission member 4 includes a first driving cam 41, a first bending plate 42 and a first straight slider 43. The first driving cam 41 is an end cam and has three first main convex portions 411, three first main concave portions 412, a first main penetration hole 413 and two first protrusions 414. The first main convex portions 411 extend outward along the first axis X1 and are spaced apart from each other. The first main concave portions 412 are respectively formed between any two of the first main convex portions 411 and are spaced apart from each other. The first main penetration hole 413 is formed through along the first axis X1 and is used for the first shaft 21 to insert through. The first protrusions 414 are roughly semi-arc-shaped blocks, extend outward along the first axis X1, spaced apart from each other and facing away from the first main convex portions 411. The first bending plate 42 is substantially L-shaped, extends outward from the first driving cam 41 along the radial direction of the first axis X1 and is bent. The first straight slider 43 is formed to extend outward from the first bending plate 42 along the radial direction of the first axis X1, that is, two sides of the first bending plate 42 are respectively connected to the first driving cam 41 and the first straight slider 43.

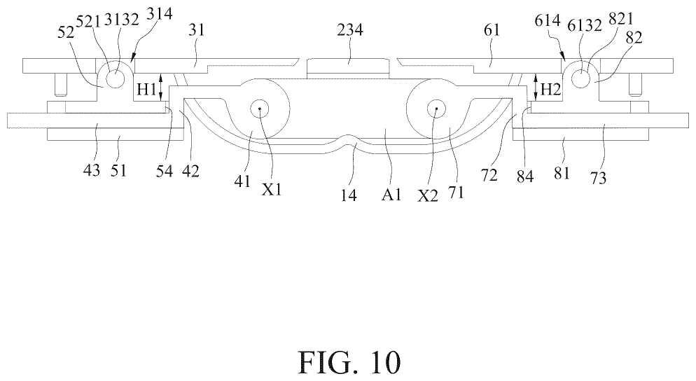

The first connecting member 5 includes a first body 51, a first pivoting portion 52, a first straight slide groove 53 and a first inner recess portion 54. The first body 51 is roughly square, and the first pivoting portion 52 is roughly a hollow cylinder disposed on the top side of the first body 51, so that the first body 51 and the first pivoting portion 52 jointly have a roughly T-shaped cross-section. The first pivoting portion 52 has a first pivoting hole 521 for the first rod body 3132 to insert through, so that the first pivoting portion 52 is located between the first body 51 and the first wing member 31 and is partially accommodated in the first receiving groove 314 (see FIG. 10), whereby the first pivoting portion 52 can rotate relative to the first wing member 31 about the first outer virtual axis V3. The first straight slide groove 53 is surrounded and defined by the first body 51 and extends along the radial direction of the first axis X1, and the first straight slider 43 is slidably disposed in the first straight slide groove 53, whereby the first connecting member 5 can linearly slide relative to the first transmission member 4. The first inner recess portion 54 is recessed and formed in the first body 51 at one end adjacent to the first transmission member 4 and is connected to the first straight slide groove 53. There is a first vertical distance H1 (see FIG. 10) between the first inner recess portion 54 and the first wing member 31.

The second panel body 6 is arranged opposite to the first panel body 3 and includes a second wing member 61 and a second panel housing 62. The second wing member 61 has a second wing body 611, two second arc-shaped slideways 612, a second connecting rod portion 613 and a second receiving groove 614. The second wing body 611 is roughly in the shape of a square plate. The second arc-shaped slideways 612 are spaced apart from each other, recessed and formed on one side of the second wing body 611 adjacent to the body portion 11, and are respectively provided for the second arc-shaped sliders 13 to slide correspondingly, so that the second wing member 61 can pivot relative to the body portion 11 with the second inner virtual axis V2 as the center. The second connecting rod portion 613 has two second pivot joint holes 6131 and a second rod body 6132. The second pivot joint holes 6131 correspond to each other and are spaced apart from each other, and are penetrated along a second outer virtual axis V4. Two opposite ends of the second rod body 6132 are respectively passed through the second pivot joint holes 6131. The second receiving groove 614 is formed through the second wing body 611 and is located correspondingly between the second pivot joint holes 6131. In addition, the second panel body 6 also includes electronic components, which will not be described in detail here.

The second transmission member 7 is spaced apart from the first transmission member 4 and includes a second driving cam 71, a second bending plate 72 and a second straight slider 73. The second driving cam 71 is an end cam and has three second main convex portions 711, three second main concave portions 712, a second main penetration hole 713 and two second protrusions 714. The second main convex portions 711 extend outward along the second axis X2 and are spaced apart from each other. The second main concave portions 712 are respectively formed between any two of the second main convex portions 711 and are spaced apart from each other. The second main penetration hole 713 is formed through along the second axis X2 and is used for the second shaft 22 to insert through. The second protrusions 714 are roughly semi-arc-shaped blocks, extend outward along the second axis X2, spaced apart from each other and facing away from the second main convex portions 711. The second bending plate 72 is substantially L-shaped, extends outward from the second driving cam 71 along the radial direction of the second axis X2 and is bent. The second straight slider 73 is formed to extend outward from the second bending plate 72 along the radial direction of the second axis X2, that is, two sides of the second bending plate 72 are respectively connected to the second driving cam 71 and the second straight slider 73.

The second connecting member 8 includes a second body 81, a second pivoting portion 82, a second straight slide groove 83 and a second inner recess portion 84. The second body 81 is roughly square, and the second pivoting portion 82 is roughly a hollow cylinder disposed on the top side of the second body 81, so that the second body 81 and the second pivoting portion 82 jointly have a roughly T-shaped cross-section. The second pivoting portion 82 has a second pivoting hole 821 for the second rod body 6132 to insert through, so that the second pivoting portion 82 is located between the second body 81 and the second wing member 61 and is partially accommodated in the second receiving groove 614 (see FIG. 10), whereby the second pivoting portion 82 can rotate relative to the second wing member 61 about the second outer virtual axis V4. The second straight slide groove 83 is surrounded and defined by the second body 81 and extends along the radial direction of the second axis X2, and the second straight slider 73 is slidably disposed in the second straight slide groove 83, whereby the second connecting member 8 can linearly slide relative to the second transmission member 7. The second inner recess portion 84 is recessed and formed in the second body 81 at one end adjacent to the second transmission member 7 and is connected to the second straight slide groove 83. There is a second vertical distance H2 (see FIG. 10) between the second inner recess portion 84 and the second wing member 61.

The synchronization module 9 includes a first main gear 91, a second main gear 92, a first auxiliary gear 93, a second auxiliary gear 94 and a gear fixing piece 95. The first main gear 91 has a first gear body 911, a first penetration hole 912 and two first fixing blocks 913. The first gear body 911 is in the shape of a gear. The first penetration hole 912 penetrates through the first gear body 911 and is used for the first shaft 21 to insert through. The first fixing blocks 913 are semi-arc blocks, extend outward from the first gear body 911, and are spaced apart from each other, and are respectively matched and clamped between the first protrusions 414 of the first driving cam 41, so that the first main gear 91 is fixedly connected to the first transmission member 4 and rotates synchronously therewith. The second main gear 92 has a second gear body 921, a second penetration hole 922 and two second fixing blocks 923. The second gear body 921 is in the shape of a gear. The second penetration hole 922 penetrates through the second gear body 921 and is used for the second shaft 22 to insert through. The second fixing blocks 923 are semi-arc blocks, extend outward from the second gear body 921, and are spaced apart from each other, and are respectively matched and clamped between the second protrusions 714 of the second driving cam 71, so that the second main gear 92 is fixedly connected to the second transmission member 7 and rotates synchronously therewith. The first auxiliary gear 93 has two first positioning tenons 931 extending reversely along a direction parallel to the first axis X1, and the second auxiliary gear 94 has two second positioning tenons 941 extending reversely along a direction parallel to the second axis X2. The gear fixing piece 95 has a first through hole 951, a second through hole 952 and two holes 953 which are spaced apart from each other. The first through hole 951 is formed along the first axis X1 and is used for the first fixing blocks 913 and the first shaft 21 to insert through. The second through hole 952 is formed along the second axis X2 and is used for the second fixing blocks 923 and the second shaft 22 to insert through. The holes 953 are penetrated along a direction parallel to the first axis X1 or the second axis X2 and are located between the first through hole 951 and the second through hole 952. The first positioning tenons 931 are pivotally connected to one of the concave holes 111 and one of the holes 953, and the second positioning tenons 941 are pivotally connected to the other of the concave holes 111 and the other of the holes 953. Therefore, the gear fixing piece 95 is arranged between the first main gear 91, the second main gear 92, the first auxiliary gear 93, the second auxiliary gear 94 and the first transmission member 4 and the second transmission member 7, and the first main gear 91, the second main gear 92, the first auxiliary gear 93 and the second auxiliary gear 94 are arranged between the gear fixing piece 95 and the body portion 11. The first auxiliary gear 93 and the second auxiliary gear 94 mesh with each other, are located between the first main gear 91 and the second main gear 92, and are reversely rotatably connected to the body portion 11. The first auxiliary gear 93 is reversely rotatably engaged with the first main gear 91, and the second auxiliary gear 94 is reversely rotatably engaged with the second main gear 92. By the coordination among the first main gear 91, the second main gear 92, the first auxiliary gear 93 and the second auxiliary gear 94, the first transmission member 4 and the second transmission member 7 can rotate synchronously and reversely.

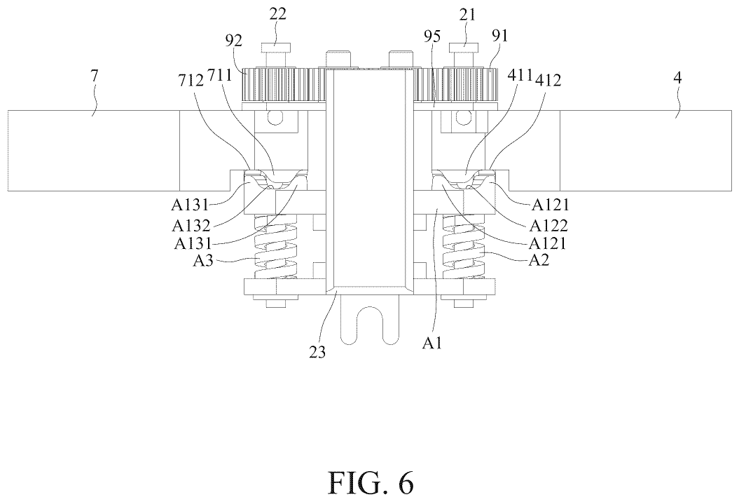

The elastic module A includes a pushing member A1, a first elastic member A2 and a second elastic member A3. The pushing member A1 is slidably sleeved on the first shaft 21 and the second shaft 22 at the same time, and has a pushing body A11, a first driven cam A12 and a second driven cam A13. The pushing body A11 is roughly in the shape of a rectangular body. The first driven cam A12 is an end cam, extends outward from one of the two opposite sides of the pushing body A11, and movably engaged with the first driving cam 41 (see FIG. 6 to FIG. 8). The first driven cam A12 has three first driven convex portions A121, three first driven concave portions A122 and a first driven penetration hole A123. The first driven convex portions A121 extend outward along the first axis X1 and are spaced apart from each other. The first driven concave portions A122 are respectively formed between any two of the first driven convex portions A121 and are spaced apart from each other. The first driven penetration hole A123 is formed through along the first axis X1 and is used for the first shaft 21 to insert through. The first driven penetration hole A123 has a circular cross-sectional area larger than the first shaft 21, so that the first driven cam A12 can slide on the first shaft 21 but does not rotate synchronously. The second driven cam A13 is an end cam, extends outward from the other of the two opposite sides of the pushing body A11, and movably engaged with the second driving cam 71 (see FIG. 6 to FIG. 8). The second driven cam A13 has three second driven convex portions A131, three second driven concave portions A132 and a second driven penetration hole A133. The second driven convex portions A131 extend outward along the second axis X2 and are spaced apart from each other. The second driven concave portions A132 are respectively formed between any two of the second driven convex portions A131 and are spaced apart from each other. The second driven penetration hole A133 is formed through along the second axis X2 and is used for the second shaft 22 to insert through. The second driven penetration hole A133 has a circular cross-sectional area larger than the second shaft 22, so that the second driven cam A13 can slide on the second shaft 22 but does not rotate synchronously. The first elastic member A2 is sleeved on the first shaft 21 and its two ends respectively abut against the first wing portion 232 and the first driven cam A12. The second elastic member A3 is sleeved on the second shaft 22 and its two ends respectively abut against the second wing portion 233 and the second driven cam A13. In one embodiment, the first elastic member A2 and the second elastic member A3 are respectively a compression spring.

The flexible screen B is disposed on the first panel body 3, the second panel body 6 and the central base 1, and includes a bendable area B1. The bendable area B1 roughly corresponds to the central base 1, the first wing member 31 and the second wing member 61.

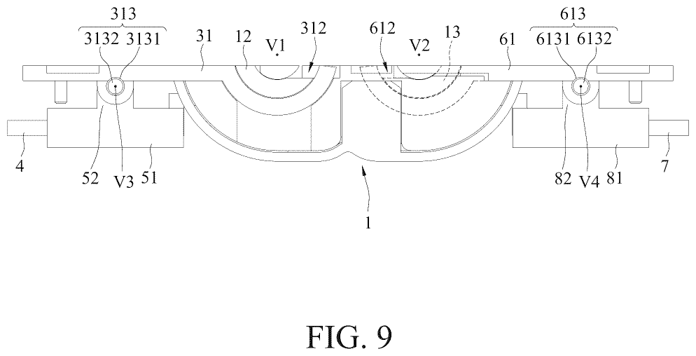

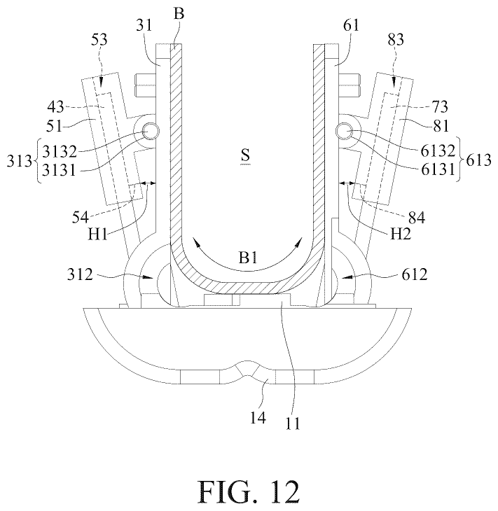

The following describes the operation of the foldable electronic device 1000 of the present disclosure. The first panel body 3 and the second panel body 6 are able to transform between an unfolded state (see FIG. 9 and FIG. 10) and a folded state (see FIG. 12). In the unfolded state, the flexible screen B is flattened, the first panel body 3, the second panel body 6 and the central base 1 jointly support the bendable area B1, and the first wing member 31 and the second wing member 61 abut against the top side of the shell 14. As shown in FIG. 6 (only the pivot module 2, the first transmission member 4, the second transmission member 7, the synchronization module 9 and the elastic module A are shown), at this time, the first driving cam 41 and the first driven cam A12 are matched and engaged with each other. That is, each of the first main convex portions 411 extends into each of the first driven concave portions A122, and one side surface of each of the first main convex portions 411 partially contacts one side surface of each of the first driven convex portions A121, generating friction. The sum of the lengths of the first driving cam 41 and the first driven cam A12 on the first axis X1 is the smallest. The second driving cam 71 and the second driven cam A13 are matched and engaged with each other. That is, each of the second main convex portions 711 extends into each of the second driven concave portions A132, and one side surface of each of the second main convex portions 711 partially contacts one side surface of each of the second driven convex portions A131, generating friction. The sum of the lengths of the second driving cam 71 and the second driven cam A13 on the second axis X2 is the smallest, and the first elastic member A2 and the second elastic member A3 are correspondingly released (i.e., the compression amount is the smallest). At the same time, as shown in FIG. 10, the first bending plate 42 is accommodated in the first inner recess portion 54, the second bending plate 72 is accommodated in the second inner recess portion 84, the first body 51 and the first wing member 31 are substantially parallel to each other, the second body 81 and the second wing member 61 are substantially parallel to each other, and the first vertical distance H1 and the second vertical distance H2 are maximum.

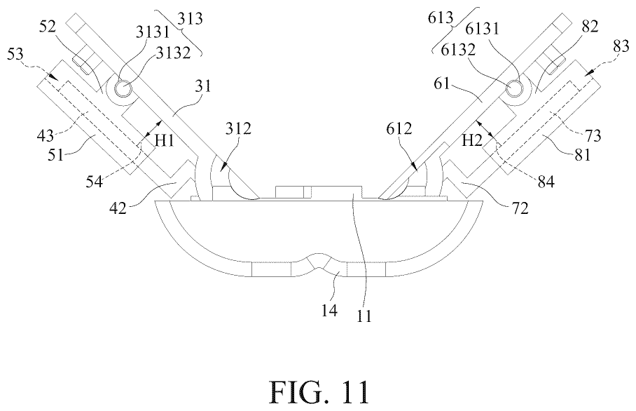

When transforming from the unfolded state to the folded state, the first wing member 31 and the second wing member 61 pivot relative to the body portion 11 about the first inner virtual axis V1 and the second inner virtual axis V2 as the center, respectively, and gradually approach each other. At this time, the first connecting member 5 and the second connecting member 8 are also pivotally moved relative to the first wing member 31 and the second wing member 61 with the first outer virtual axis V3 and the second outer virtual axis V4 as the center, respectively, so that the first straight slider 43 and the second straight slider 73 slide linearly in the first straight slide groove 53 and the second straight slide groove 83 respectively (i.e., the first straight slider 43 and the second straight slider 73 gradually change from partially protruding from the first straight slide groove 53 and the second straight slide groove 83 respectively to not protruding, as shown in FIG. 10 to FIG. 11). At the same time, the first driving cam 41 and the first bending plate 42 pivot about the first axis X1, and the second driving cam 71 and the second bending plate 72 pivot about the second axis X2. Since the first main gear 91 is fixedly connected to the first driving cam 41 and moves together, and the second main gear 92 is fixedly connected to the second driving cam 71 and moves together, the first auxiliary gear 93 and the second auxiliary gear 94 which respectively mesh with the first main gear 91 and the second main gear 92 can drive the first transmission member 4 and the second transmission member 7 to rotate synchronously and reversely. At the same time, the first bending plate 42 gradually moves away from the first inner recess portion 54, and the second bending plate 72 gradually moves away from the second inner recess portion 84. The first inner recess portion 54 gradually approaches the first wing member 31 so that the first body 51 and the first wing member 31 are no longer parallel to each other. The second inner recess portion 84 gradually approaches the second wing member 61 so that the second body 81 and the second wing member 61 are no longer parallel to each other. The first vertical distance H1 and the second vertical distance H2 gradually decrease.

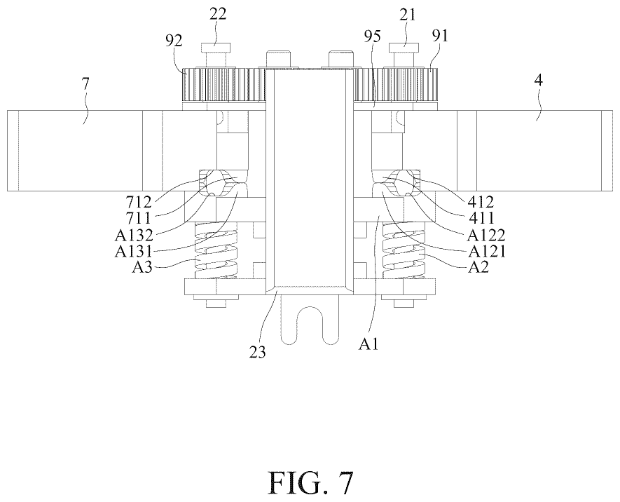

In the process of transforming from the unfolded state to the folded state, the first driving cam 41 gradually pushes the first driven cam A12 away, the second driving cam 71 gradually pushes the second driven cam A13 away, the pushing member A1 moves toward the fixed base 23 along the first shaft 21 and the second shaft 22, and gradually compresses the first elastic member A2 and the second elastic member A3 (i.e., the compression amount gradually increases). When transforming to a half-folded state between the unfolded state and the folded state, as shown in FIG. 7 (only the pivot module 2, the first transmission member 4, the second transmission member 7, the synchronization module 9 and the elastic module A are shown), the first driving cam 41 and the second driving cam 71 are respectively in a mutually abutting state with the first driven cam A12 and the second driven cam A13. That is, each of the first main convex portions 411 corresponds to and abuts against each of the first driven convex portions A121, each of the first main concave portions 412 corresponds to each of the first driven concave portions A122, each of the second main convex portions 711 corresponds to and abuts against each of the second driven convex portions A131, and each of the second main concave portions 712 corresponds to each of the second driven concave portions A132. At this time, the compression amount is the greatest. Furthermore, the sum of the lengths of the first driving cam 41 and the first driven cam A12 on the first axis X1 is the greatest, and the sum of the lengths of the second driving cam 71 and the second driven cam A13 on the second axis X2 is the greatest.

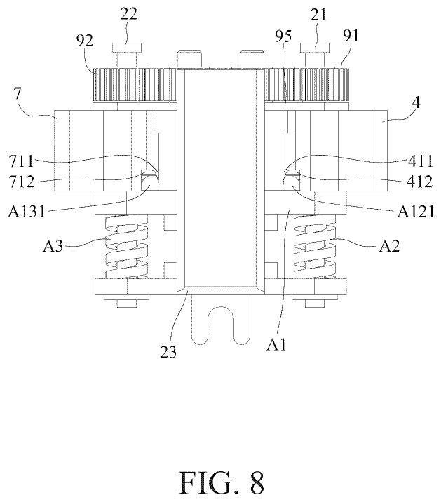

When further transforming to the folded state, as shown in FIG. 8 (only the pivot module 2, the first transmission member 4, the second transmission member 7, the synchronization module 9 and the elastic module A are shown), the first driving cam 41 and the first driven cam A12 gradually become matched and engaged with each other. That is, each of the first main convex portions 411 gradually penetrates into each of the first driven concave portions A122, and the side surface of each of the first driving convex portions 411 partially contacts the side surface of each of the first slave protrusions A121 (contacts on the other side) and generates friction. The second driving cam 71 and the second driven cam A13 also gradually become matched and engaged with each other, which will not be restated in detail. At this time, the first elastic member A2 and the second elastic member A3 are gradually released (i.e., the compression amount gradually decreases). At the same time, as shown in FIG. 12, the first bending plate 42 is away from the first inner recess portion 54, the second bending plate 72 is away from the second inner recess portion 84, the first body 51 is obliquely intersected with the first wing member 31, the second body 81 is obliquely intersected with the second wing member 61, and the first vertical distance H1 and the second vertical distance H2 are minimum.

Referring to FIG. 12, when transforming to the folded state, the total length of the first driving cam 41 and the first driven cam A12 on the first axis X1 is minimized, while the sum of the lengths of the second driving cam 71 and the second driven cam A13 on the second axis X2 is minimized, and the first elastic member A2 and the second elastic member A3 are released. The first wing member 31 and the second wing member 61 are away from the top side of the shell 14. At this time, the first wing member 31 and the second wing member 61 are roughly perpendicular to the body portion 11, and the bendable area B1 of the flexible screen B is bent. The first panel body 3, the second panel body 6 and the central base 1 jointly define an accommodation space S to accommodate the bendable area B1, and the bendable area B1 is roughly U-shaped.

To sum up, in the foldable electronic device of the present disclosure, the first connecting member and the second connecting member pivot relative to the first wing member and the second wing member, respectively, and the first transmission member and the second transmission member are driven to slide linearly relative to the first connecting member and the second connecting member, respectively. Therefore, the present disclosure improves the structural complexity of the existing structure, such as the need to add additional slide grooves on the wing members and the need for the transmission members to be connected to the wing members via the sliding pins.

What is claimed is:

1. A foldable electronic device, comprising:
a central base including a body portion, at least one first arc-shaped slider, at least one second arc-shaped slider and a shell, wherein the first arc-shaped slider and the second arc-shaped slider are respectively formed on the body portion and spaced apart from each other;
a pivot module disposed in the central base and including a first shaft and a second shaft connected to the body portion, wherein the first shaft extends along a first axis, and the second shaft extends along a second axis;
a first panel body including a first wing member, wherein the first wing member has at least one first arc-shaped slideway and a first connecting rod portion, and the first arc-shaped slider is slidably disposed in the first arc-shaped slideway, so that the first wing member is able to pivot relative to the body portion with a first inner virtual axis as a center;
a first transmission member sleeved on the first shaft;
a first connecting member including a first pivoting portion and a first straight slide groove, wherein the first pivoting portion is pivotally connected to the first connecting rod portion and jointly defines a first outer virtual axis, so that the first connecting member is able to rotate relative to the first wing member about the first outer virtual axis, and wherein the first transmission member is slidably disposed in the first straight slide groove, so that the first connecting member is able to slide linearly relative to the first transmission member;
a second panel body including a second wing member, wherein the second wing member has at least one second arc-shaped slideway and a second connecting rod portion, and the second arc-shaped slider is slidably disposed in the second arc-shaped slideway, so that the second wing member is able to pivot relative to the body portion with a second inner virtual axis as a center;
a second transmission member sleeved on the second shaft;
a second connecting member including a second pivoting portion and a second straight slide groove, wherein the second pivoting portion is pivotally connected to the second connecting rod portion and jointly defines a second outer virtual axis, so that the second connecting member is able to rotate relative to the second wing member about the second outer virtual axis, and wherein the second transmission member is slidably disposed in the second straight slide groove, so that the second connecting member is able to slide linearly relative to the second transmission member;
a synchronization module connecting the first transmission member and the second transmission member, and enabling the first transmission member and the second transmission member to rotate synchronously and reversely;
an elastic module including a pushing member, wherein the pushing member is slidably sleeved on the first shaft and the second shaft and is movably engaged with the first transmission member and the second transmission member; and
a flexible screen disposed on the first panel body, the second panel body and the central base, and including a bendable area;
wherein the first panel body and the second panel body are able to transform between an unfolded state and a folded state, wherein when the first panel body and the second panel body are in the unfolded state, the flexible screen is flattened, the first panel body, the second panel body and the central base jointly support the bendable area, and the first wing member and the second wing member abut against a top side of the shell, and wherein when the first panel body and the second panel body are in the folded state, the bendable area of the flexible screen is bent, the first panel body, the second panel body and the central base jointly define an accommodation space to accommodate the bendable area, and the first wing member and the second wing member are away from the shell.

2. The foldable electronic device of claim 1, wherein the first connecting member further includes a first body, the first pivoting portion is disposed on the first body and located between the first body and the first wing member, the first straight slide groove is surrounded and defined by the first body and extends along a radial direction of the first axis, and wherein the second connecting member further includes a second body, the second pivoting portion is disposed on the second body and located between the second body and the second wing member, the second straight slide groove is surrounded and defined by the second body and extends along a radial direction of the second axis, wherein when the first panel body and the second panel body are in the unfolded state, the first body and the first wing member are approximately parallel to each other, and the second body and the second wing member are approximately parallel to each other, and wherein when the first panel body and the second panel body are in the folded state, the first body and the first wing member are obliquely intersected, and the second body and the second wing member are obliquely intersected.

3. The foldable electronic device of claim 2, wherein the first connecting member further includes a first inner recess portion disposed in the first body, and there is a first vertical distance between the first inner recess portion and the first wing member, and the second connecting member further includes a second inner recess portion disposed in the second body, and there is a second vertical distance between the second inner recess portion and the second wing member, wherein the first vertical distance and the second vertical distance are the greatest when the first panel body and the second panel body are in the unfolded state, and wherein the first vertical distance and the second vertical distance are the smallest when the first panel body and the second panel body are in the folded state.

4. The foldable electronic device of claim 3, wherein the first transmission member includes a first bending plate, the first bending plate extends along a radial direction of the first axis and is bent, wherein the second transmission member includes a second bending plate, the second bending plate extends along a radial direction of the second axis and is bent, and wherein when the first panel body and the second panel body are in the unfolded state, the first bending plate is accommodated in the first inner recess portion and the second bending plate is accommodated in the second inner recess portion, and wherein when the first panel body and the second panel body are in the folded state, the first bending plate is away from the first inner recess portion and the second bending plate is away from the second inner recess portion.

5. The foldable electronic device of claim 4, wherein the first transmission member further includes a first straight slider, and the first straight slider extends outward from the first bending plate along the radial direction of the first axis and is slidably disposed in the first straight slide groove, and wherein the second transmission member further includes a second straight slider, and the second straight slider extends outward from the second bending plate along the radial direction of the second axis and is slidably disposed in the second straight slide groove.

6. The foldable electronic device of claim 5, wherein the synchronization module includes a first main gear, a second main gear, a first auxiliary gear and a second auxiliary gear, wherein the first main gear is sleeved on the first shaft and fixedly connected to the first transmission member to move together with the first transmission member, the second main gear is sleeved on the second shaft and fixedly connected to the second transmission member to move together with the second transmission member, and the first auxiliary gear and the second auxiliary gear are reversely rotatably connected to the body portion and mesh with each other, and wherein the first auxiliary gear is reversely rotatably engaged with the first main gear, and the second auxiliary gear is reversely rotatably engaged with the second main gear.

7. The foldable electronic device of claim 6, wherein the synchronization module further includes a gear fixing piece, and the gear fixing piece has a first through hole and a second through hole, and wherein the first shaft and the first main gear insert through the first through hole, and the second shaft and the second main gear insert through the second through hole, so that the gear fixing piece is disposed between the first main gear and the second main gear and the first transmission member and the second transmission member, and wherein the first main gear, the second main gear, the first auxiliary gear and the second auxiliary gear are disposed between the body portion and the gear fixing piece.

8. The foldable electronic device of claim 7, wherein the first body and the first pivoting portion jointly have a roughly T-shaped cross section, and the second body and the second pivoting portion jointly have a roughly T-shaped cross section.

9. The foldable electronic device of claim 8, wherein the first axis, the first inner virtual axis, the first outer virtual axis, the second axis, the second inner virtual axis and the second outer virtual axis are parallel to each other.

10. The foldable electronic device of claim 1, wherein the first connecting rod portion has two first pivot joint holes and a first rod body, the first pivoting portion is roughly a hollow cylinder and has a first pivoting hole, the first pivot joint holes are corresponding to and spaced apart from each other and are formed along the first outer virtual axis, and the first rod body passes through the first pivoting hole and two opposite ends of the first rod body respectively insert through the first pivot joint holes, wherein the second connecting rod portion has two second pivot joint holes and a second rod body, the second pivoting portion is roughly a hollow cylinder and has a second pivoting hole, the second pivot joint holes are corresponding to and spaced apart from each other and are formed along the second outer virtual axis, and the second rod body passes through the second pivoting hole and two opposite ends of the second rod body respectively insert through the second pivot joint holes.

11. The foldable electronic device of claim 10, wherein the first transmission member includes a first driving cam, the second transmission member includes a second driving cam, and the pushing member has a first driven cam and a second driven cam, and wherein the first driving cam is slidably sleeved on the first shaft along the first axis and fits with the first driven cam, and the second driving cam is slidably sleeved on the second shaft along the second axis and fits with the second driven cam.

12. The foldable electronic device of claim 11, wherein the pivot module further includes a fixed base, a first shaft hole and a second shaft hole, and the fixed base has a first wing portion and a second wing portion, wherein the first shaft hole is formed through the first wing portion along the first axis, and the first shaft inserts through the first shaft hole, and wherein the second shaft hole is formed through the second wing portion along the second axis, and the second shaft inserts through the second shaft hole.

13. The foldable electronic device of claim 12, wherein the first driven cam is sleeved on the first shaft, and the second driven cam is sleeved on the second shaft, wherein the elastic module further includes a first elastic member and a second elastic member respectively sleeved on the first shaft and the second shaft, two ends of the first elastic member respectively abut against the first wing portion and the first driven cam, and two ends of the second elastic member respectively abut against the second wing portion and the second driven cam, wherein when the first panel body and the second panel body are in a half-folded state between the unfolded state and the folded state, the first driving cam and the second driving cam abut against the first driven cam and the second driven cam, the first elastic member and the second elastic member are compressed, and wherein when the first panel body and the second panel body are in the unfolded state or the folded state, the first elastic member and the second elastic member are released correspondingly.
